(19) United States
(12) Patent Application Publication
(10) Pub. No.: US 2007/0176064 A1
(43) Pub. Date: Aug. 2, 2007

(54) Quick mount

(76) Inventor: Carl Dean Lacy, Canton, MS (US)

Correspondence Address: CARL DEAN LACY, 933 MARY COURT, CANTON, MS, 39046, US

(21) Appl. No.: 11/345,472

(22) Filed: Feb. 1, 2006

(51) Int. Cl. A47G 1/17; F16B 47/00; A47G 29/00

(52) U.S. Cl. 248/205.3

(57) ABSTRACT

This invention relates to a mounting bracket which are mirror image of each other for use in mounting window blind. A pair of bracket for hanging a window blind with achieve backing double sided achieve tape and or glue achieve applied with peel off tab which can be applied to either top, side, and or back which are both easy to install. Each bracket includes a 4 sided mount with an open end for receiving the head rail. Prior to hanging the bracket and intermediate support, simply locate the position on the window frame and or wall, peel off achieve tab on the bracket and intermediate support an attach to window frame and or wall. Repeat for other bracket and simply screw bracket to frame.

### BACKGROUND OF THE INVENTION

Present curtain rod mounting bracket, window shade mounting bracket, window blind mounting bracket, and drapers mounting bracket all come with great difficulties in mounting to the window frame and or wall. This drawback creates uneven mounts, frustration, and tired arms.

With present mount devices requires the use of both hands and fingers to hold the mount in place, the screw/nail, screwdriver/power tool to mount the bracket in place.

Further, some bracket are quite complicated and difficulties to install.

Other brackets require specific types of window frames and thus lack the versatility necessary for use with a wide variety of window frame and wall types.

No bracket allow the accommodation of a achieve backing for easy mounting to window frame and wall.

U.S. Pat. Nos. 2,099,770 and 4,399,917 overcome some of the drawbacks associated with standard curtain rod mounting brackets by allowing the mounting of multiple curtain rods at different height.

U.S. Pat. No. 2,009,770 is a curtain fixture that can be attached a window frame without the use of screws or mails. The fixture is held in place by the force of springs that urge hinged arms together, clamping the window frame between the arms. Brackets for holding curtain rods can be positioned at various heights by engaging two of a number of vertically aligned hooks positioned at various heights on one of the bracket's arms.

This curtain fixture requires different left and right brackets.

U.S. Pat. No. 4,399,917 is a dual curtain rod assembly and includes two curtain rods as mounting brackets and spacer bars that hold the two rods a fixed distance apart, one directly above the other, forming a rigid structure for mounting on a wall.

Though U.S. Pat. No. 2,099,770 offers the advantage of mounting multiple curtain rods at a variety of heights. Further, as this device uses spring tension for attachment onto window frames, it may not be able to support heavy curtains and curtain rods. Also, this device can only be mounted on certain types and sizes of window frames, thus increasing installation complexity,

U.S. Pat. No. 4,399,917 this device requires the user to assemble the structure, as well as position on a wall or window frame. As the dual curtain rod assembly can be quite large and cumbersome, installing the assembled structure may be difficult.

U.S. Pat. No. 5,265,837 this device requires the user to hold the bracket in place, while mounting the bracket to the window frame and or wall.

U.S. Pat. No. 6,279,863 B1 this device requires the user to hold the bracket in place, while mounting the bracket to the window frame and or wall.

U.S. Pat. No. 5,564,666 this device requires the user to hold the bracket in place, while mounting the bracket to the window frame and or wall.

Moreover, in the devices described in either patent, variation in vertical positions of the brackets is limited.

Neither device allows the user to simple attach the bracket to the window frame and or wall without holding the bracket in place while mounting the bracket. Such a feature would greatly increase the consumers appreciation for easier installation.

It would therefore be desirable to provide a mounting bracket that will allow installation to be quick and easier.

It would be desirable to provide a mounting bracket that can accommodate more than one mounting problem.

It would be still further desirable to provide a mounting bracket that is inexpensive to manufacture, and simple to install and is easily customizable.

It would be still further desirable to provide a mounting bracket that can be used on a large variety of wall and window frame types.

### SUMMARY OF THE INVENTION

It is therefore an object of this invention to provide a mounting bracket with achieve backing to be applied to any side for the mounting of said bracket that will allow the mounting of a heading rail, curtain, drapers, shades, without holding the bracket while mounting it to the window frame and or wall.

It is still another object of this invention to provide a mounting bracket that can accommodate more than one side of achieve for mounting.

It is still another object of this invention to provide a mounting bracket that is inexpensive to manufacture, simple to install and is easily customizable.

It is still another object of this invention to provide a mounting bracket that can be used on a large variety of wall and window frame types.

It is still another object of this invention to provide an opportunity for the consumer(s) to spend less time in concentrating on the positioning of the window bracket(s), fingers, hands, and tool while installing the window bracket(s).

These and other objects of the invention are accomplished in accordance with the principles of the invention by providing a mounting bracket for use in mounting blinds, curtains, drapers, and shades with achieves backing to hold the brackets in place while mounting the bracket to the window frame and or wall.

### BRIEF DESCRIPTION OF THE DRAWINGS

The above and other objects and advantages of this invention will be apparent upon consideration of the following detailed description, taken in conjunction with the accompany drawings, in which like reference numbers refer to like parts throughout and in which:

FIG. 1 is a front view of the mounting bracket with sticky achieve fixed to a window frame.

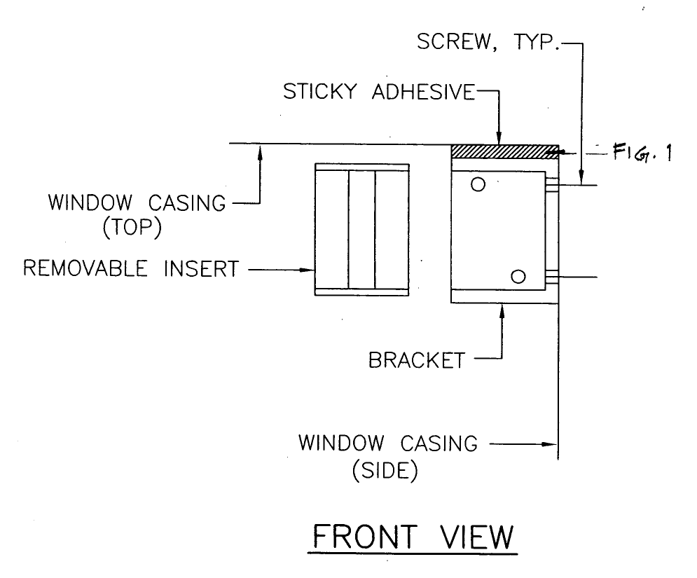

FIG. 2 is a side view of the mounting bracket with sticky achieve fixed to a window frame.

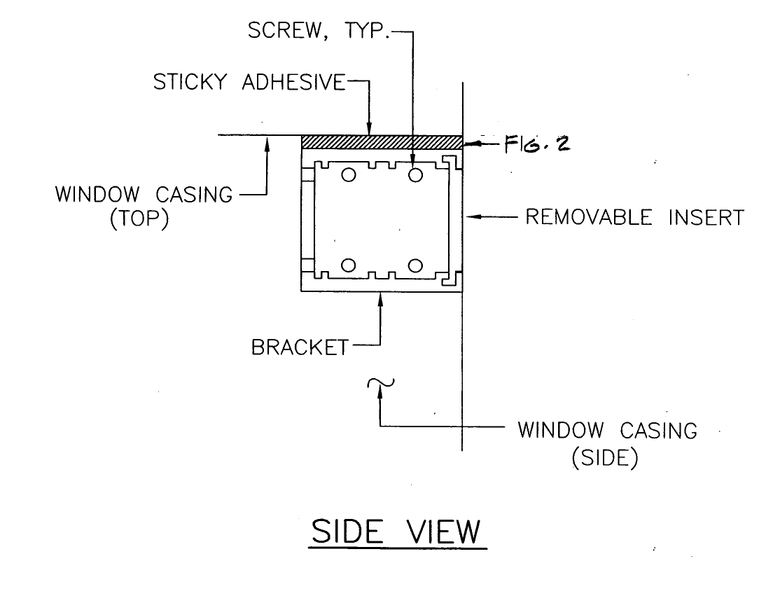

FIG. 3 is a front view of the intermediate support bracket with sticky achieve fixed to a window frame.

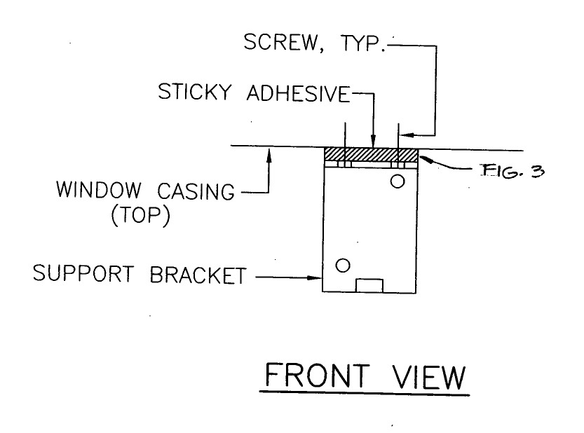

FIG. 4 is a side view of the intermediate support bracket with sticky achieve fixed to a window frame.

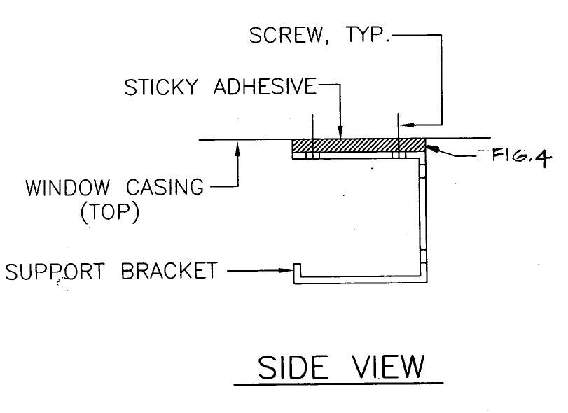

1. What I claim as my invention is the double sided achieve tape and or the glue achieve applied with peel off tab to window bracket side, top, and or back as shown and described.
